(19) United States
(12) Patent Application Publication
(10) Pub. No.: US 2020/0340923 A1
(43) Pub. Date: Oct. 29, 2020

(54) A SENSOR COMPRISING A NANOPOROUS MATERIAL AND METHOD FOR DETECTING AN ANALYTE USING THE SENSOR

(71) Applicant: Nano Optical Sensor Equipment Solutions Ltd, London (GB)

(72) Inventor: Jeremy Joachim Ramsden, Bedfordshire (GB)

(21) Appl. No.: 16/956,372

(22) PCT Filed: Dec. 19, 2018
(86) PCT No.: PCT/EP2018/085977

§ 371 Date: Jun. 19, 2020

(30) Foreign Application Priority Data
Dec. 19, 2017 (GB) 1721314.1

(51) Int. Cl. G01N 21/77

(52) U.S. Cl. CPC G01N 21/7703; G01N 2021/773; G01N 2201/0612; G01N 2201/08; G01N 2021/7779

(57) ABSTRACT

A sensor for use in detecting an analyte, the sensor comprising a monofibre waveguide and a reactive film comprising a nanoporous material disposed at a distal end of the monofibre waveguide. The sensor is rugged, highly sensitive, and allows for rapid detection of analytes in very low amounts.

The present invention relates to an analyte sensor based on nanoporous materials. The sensors of the present invention are rugged, highly sensitive, and allow for rapid detection of analytes in very low amounts.

### BACKGROUND

The quality of ambient air, breathed by human beings, is becoming a matter of increasing concern. The plethora of artificial compounds that have become an essentially indispensable part of modern agroindustrial civilization are often toxic when inhaled. True to the old dictum of von Hohenheim (Paracelsus), namely “the poison is in the dose”, it is highly desirable to be able to quantify the presence of potentially toxic substances and, in particular, to be able to alert a breather to the sudden presence of one or more of them.

For example, neurotoxic organophosphates, notably tricresyl phosphate, are an indispensable component of jet engine lubricants. The modern system of heating and pressurizing the cabins of large jet airliners by bleeding air off the engines inevitably causes small amounts of these neurotoxins to almost continuously leak into the aircraft cabin. Although short exposures at very low concentrations may be below the toxicity threshold (if there is one) for the majority of the population, so-called “fume events” can occur, when products of pyrolysed jet engine oil leak into the cabin of an aircraft. These fume events are typically caused by the abrupt failure of critical system components, especially the oil seals, and may result in the sudden ingress of larger, potentially toxic, amounts of organophosphates and other compounds into the cabin air and it would be very important to be able to continuously monitor aircraft cabin air in order to swiftly alert the pilot and other aircrew to such a situation, which could potentially lead to their incapacitation during flight if no action were taken.

Furthermore, it appears that for some people endowed with an unusual combination of genes, especially those synthesizing the enzymes concerned with detoxifying foreign substances, there is no lower toxicity threshold for the neurotoxins. For such people, which may include aircrew, it would be important to monitor the cumulative dose due to chronic low-level exposure even in the absence of a fume event.

Currently there is no system able to continuously monitor aircraft cabin air for neurotoxins. Presently available methods for monitoring such contamination are based on pumping the air through a container filled with absorbent material. Post-flight, the absorbate is released and analysed in a ground-based laboratory. Hence, there is no real-time monitoring. Real-time techniques are either nonspecific for all contaminants (e.g., a photo-ionization detector) or based on a combination of gas chromatography (GC) and mass spectrometry (MS). However, GC-MS devices of sufficient sensitivity to be useful are far too heavy, bulky, and power-hungry to be carried routinely on board aircraft.

Thus it is desirable to provide a reliable, rugged, accurate and portable sensor/dosimeter to provide accurate and sensitive detection of analytes in the field, such as for monitoring aircraft cabin air for contamination, and for carrying on the person as an individual dosimeter.

### SUMMARY OF THE INVENTION

In a first aspect the present invention provides a sensor for use in detecting an analyte, the sensor comprising a monofibre waveguide and a reactive film comprising a nanoporous material disposed at a distal end of the monofibre waveguide. The nanoporous material may comprises pores. The pores may be less than 100 nm in diameter. The nanoporous material may comprise an inorganic nanoporous material. The nanoporous material may comprise a zeolite. The nanoporous material may comprise a polymer. The nanoporous material may comprise a cross-linked polymer.

The nanoporous material may comprise a polymer of intrinsic microporosity. The nanoporous material may comprise a nanoporous sol-gel. The nanoporous material may comprise a hybrid inorganic-organic material. The nanoporous material may be a metal-organic framework. The nanoporous material may be crystalline or polycrystalline or amorphous. The nanoporous material may be provided as a plurality of nano-objects having an average particle size of less than 1000 nm. The nanoporous material may be provided as a plurality of nano-objects having an average particle size of less than 200 nm. The nanoporous material may be provided as a plurality of nano-objects having an average particle size of less than 80 nm.

In a second aspect the present invention provides an apparatus for detecting an analyte in a medium, the apparatus comprising a sensor of the invention that, in use, is placed in contact with a medium, such that, in use, an interference pattern representative of the presence of the analyte is produced due to reflexions at an interface between the monofibre waveguide and the reactive film interfering with reflexions at an interface between the reactive film and the medium. The apparatus may comprise a circulator or a Y-splitter having an input channel, an output channel and a common channel. The input channel may provide an input signal to the common channel that is reflected from the interface with the medium and provides an output signal via the common channel to the output channel. The input signal may be provided by a radiation source, wherein the radiation source is configured to provide visible light or infrared. A coherence length of the radiation source may be greater than a thickness of the reactive film. The output signal may be provided to a radiation detector. The apparatus may comprise a further sensor according to any of claims 1 to 16, wherein the nanoporous material of each sensor is different.

In a third aspect the present invention provides a method of manufacturing a sensor of the present invention, comprising providing a suspension of a plurality of particles of the nanoporous material, and bringing the monofibre waveguide into contact with the suspension to form the reactive film on a distal end of the monofibre waveguide, and subsequently withdrawing the monofibre waveguide from the suspension. The suspension may comprise a liquid phase and a surface, wherein the monofibre waveguide is immersed in the liquid phase with the longitudinal axis of the monofibre being substantially perpendicular to the surface of the liquid phase, and wherein the monofibre waveguide is subsequently withdrawn from the suspension. The suspension may comprise a liquid phase and a surface, and wherein the monofibre waveguide is immersed in the liquid phase with the longitudinal axis of the monofibre being substantially parallel to the surface of the liquid phase, and subsequently withdrawing the monofibre waveguide from the suspension, preferably at a precise speed. A pH of the suspension may be between a pKa of the monofibre waveguide and a pKa of the nanoporous material. If the particles themselves are not porous, the nanoporosity may be created by the interparticle voids. Prior to the step of contacting the monofibre waveguide with the suspension, the end of the monofibre waveguide may be brought into contact with a polyion. The nanoporous material may comprise a metal-organic framework, and the method may comprise immersing the distal end of the monofibre waveguide into a solution or solutions of the metal moiety and the organic moiety of the framework and synthesizing the metal-organic framework on the distal end of the monofibre waveguide. The method may comprise immersing the distal end of the monofibre waveguide into a solution of the metal moiety and withdrawing it and immersing it into a solution of the organic moiety of the metal-organic framework and withdrawing it (or vice versa) and optionally repeating these two steps ad libitum in order to synthesize the metal-organic framework on the distal end of the monofibre waveguide. Prior to the first immersion, the distal end of the monofibre waveguide may be chemically functionalized to ensure that the products of synthesis are bonded to the waveguide. The nanoporous material may comprise a polymer, and the method may comprise dissolving the polymer in a solvent to form a solution, immersing the distal end of the monofibre waveguide into the solution, and letting the polymer adsorb onto the distal end of the monofibre waveguide.

In a fourth aspect the present invention provides a method comprising providing a sensor comprising a monofibre waveguide and a reactive film comprising a nanoporous material, placing the sensor in contact with a medium, providing a radiation in the monofibre waveguide to produce an interference pattern due to reflexions at an interface between the monofibre waveguide and the reactive film and an interface between the reactive film and the medium, and using the interference pattern to detect the presence of the analyte in the medium.

In a fifth aspect the present invention provides a method of quantifying a concentration of an analyte in a medium, comprising (i) providing a sensor comprising a monofibre waveguide and a reactive film comprising a nanoporous material having a responsivity to the analyte; (ii) providing radiation in the monofibre waveguide and measuring a first reflected radiation; (iii) placing the sensor in contact with the analyte-containing medium, and measuring a second reflected radiation; and (v) determining a difference between the first and second reflected radiation and calculating a concentration of the analyte from the difference based on the responsivity. Concentrations of multiple analytes in a medium may be quantified by using several sensors simultaneously.

### DESCRIPTION OF THE DRAWINGS

The present invention may be understood with reference to the drawings which are described below.

FIG. 1—Scheme of an apparatus according to the present invention. L, radiation source (diode laser); T, tap coupler; D0, photodiode measuring laser output; Y1,2,3, . . . , Y-splitters; Y1a,2a,3a, . . . , Y-splitters; D1,2,3, . . . , radiation detectors are) (photodiodes); A, A/D converter; M, microprocessor/memory chip for data processing and storage; G, graphical user interface; U, USB for data download. Enlarged portion: C, connector; R, analyte-sensitive reactive film coated onto the distal end of the fibre (the first fibre is assumed to be uncoated and serve as a reference sensor for determining the refractive index of the ambient medium). The optical components (L, T, D, Y, C, R) are connected by optical fibres. The electronic components (D, A, M, G, U) are connected by electrical wires. Not shown: power supply (battery).

FIG. 2a. The sensitivity, dR₁₂₃/dn₂, of an optical fibre end-coated with a reactive film, assumed to be silica (n₁=1.452) in air (n₃=1.000274) as a function of coating thickness in nanometres. Wavelength of the illuminating light: λ=1310 nm; initial refractive index of the reactive film n₂=2.4.

FIG. 2b. The sensitivity, dR₁₂₃/dd₂, of an optical fibre end-coated with a reactive film, assumed to be silica (n₁=1.452) in air (n₃=1.000274) as a function of coating thickness in nanometres. Wavelength of the illuminating light: λ=1310 nm; refractive index of the reactive film n₂=2.4.

FIG. 2c. The sensitivities ∂R₁₂₃/∂n₂ and ∂R₁₂₃/∂d₂ (the latter with units of μm⁻¹) plotted as a function of coating thickness in nanometres. Parameters: n₁=1.452; n₂=1.335; n₃=1.000274; λ=1310 nm.

FIG. 3. Sensor response, plotted as P_{R} versus time in deciseconds, to ethanol vapour (start of exposure marked with an arrow), of a freshly cleaved silica monomode optical fibre illuminated with light of wavelength 1310 nm. After cessation of exposure the signal returns to the baseline.

FIG. 4. Scanning electron micrograph of a freshly cleaved silica monomode optical fibre end-coated with particles of MOF ZIF-8.

FIG. 5. Sensor response, plotted as P_{R} versus time in deciseconds, to ethanol vapour (start of exposure marked with an arrow), of a silica monomode optical fibre end-coated with the MOF ZIF-8 illuminated with light of wavelength 1310 nm (EXAMPLE 1).

FIG. 6. Sensor response, plotted as P_{R} versus time in deciseconds, to tributyl phosphate pyrolysed at 280° C. (start of exposure marked with an arrow), of a silica monomode optical fibre end-coated with MOF ZIF-8 illuminated with light of wavelength 1310 nm (EXAMPLE 2).

FIG. 7. Sensor response, plotted as P_{R} versus time in deciseconds, to tricresyl phosphate pyrolysed at 590° C. (start of exposure marked with an arrow), of a silica monomode optical fibre end-coated with MOF ZIF-8 illuminated with light of wavelength 1310 nm (EXAMPLE 3).

FIG. 8. Sensor response plotted as P_{R} versus time in deciseconds, to ethanol vapour (start of exposure marked with an arrow), of a silica monomode optical fibre end-coated with an aluminium fumarate MOF (commercially available as Basolite A520 from BASF) illuminated with light of wavelength 1310 nm (EXAMPLE 4).

FIG. 9. Sensor response, plotted as P_{R} versus time in deciseconds, to tricresyl phosphate pyrolysed at 590° C. (start of exposure marked with an arrow), of a silica monomode optical fibre end-coated with an aluminium fumarate MOF (commercially available as Basolite A520 from BASF) illuminated with light of wavelength 1310 nm (EXAMPLE 5).

FIG. 10. Sensor response plotted as P_{R} versus time in deciseconds, to ethanol vapour (start of exposure marked with an arrow), of a silica monomode optical fibre end-coated with magnesium formate MOF having a the formula C₂H₂MgO₄ (commercially available as Basosiv M050 from BASF) illuminated with light of wavelength 1310 nm (EXAMPLE 6).

FIG. 11. Sensor response, plotted as P_{R} versus time in deciseconds, to tricresyl phosphate pyrolysed at 590° C. (start of exposure marked with an arrow), of a silica monomode optical fibre end-coated with MOF M050 illuminated with light of wavelength 1310 nm (EXAMPLE 7).

FIG. 12. Sensor response, plotted as P_{R} versus time in deciseconds, to a transient exposure of a mixture of formaldehyde, methanol, and water vapour (start of exposure marked with a solid arrow, end of exposure marked with an open arrow) of a silica monomode optical fibre end-coated with MOF ZIF-8 illuminated with light of wavelength 1310 nm (EXAMPLE 8).

FIG. 13. Sensor response, plotted as P_{R} versus time in deciseconds, to tricresyl phosphate pyrolysed at 590° C. (start of exposure marked with an arrow), of a silica monomode optical fibre end-coated with MOF MIL-101 illuminated with light of wavelength 1310 nm (EXAMPLE 9).

FIG. 14. Sensor response, plotted as P_{R} versus time in deciseconds, to transient exposures (start of exposures marked with solid arrows, end of exposures marked with open arrows) of, from left to right: a mixture of formaldehyde, methanol and water vapour; ethanol vapour; and toluene vapour, of a silica monomode optical fibre end-coated with the PIM that is formed by the polycondensation reaction of 5,5,6,6-tetrahydroxy-3,3,3,3-tetraethyl-1,1′-spirobisindane with tetrafluoroterephthalonitrile, illuminated with light of wavelength 1310 nm (EXAMPLE 10).

FIG. 15 Sensor response, plotted as P_{R} versus time in deciseconds, to tributyl phosphate pyrolysed at 280° C., at a concentration of 4.3 ng/cm³ (start of exposure marked with an arrow), of a silica monomode optical fibre coated with a MOF of metal Co(II) and linker 4,4′-naphthalene dicarboxylic acid illuminated with light of wavelength 1310 nm. The 2nd arrow marks the cessation of exposure. (Example 11)

FIG. 16 Sensor response, plotted as P_{R} versus time in deciseconds, to toluene, over a concentration range starting at zero (first arrow) and ending at 116 μg/cm³ (second arrow), after which the toluene concentration instantaneously reverted to zero, of a silica monomode optical fibre coated with a MOF of metal Co(II) and linker 4,4′-naphthalene dicarboxylic acid illuminated with light of wavelength 1310 nm. (Example 12)

FIG. 17. Schematic diagram (not to scale) of a reactive film formed by a plurality of nanoporous nano-objects deposited on the distal end of a silica monomode optical fibre to create an end-coated fibre.

### DETAILED DESCRIPTION

Aircraft cabin air (and other interior environments) are typically contaminated with a multiplicity of volatile and semi-volatile substances. The organophosphates have been mentioned; in addition smaller molecules such as toluene, another neurotoxin, and ethanol have also been found in significant concentrations. Even if it is not deemed necessary to monitor all contaminants, their presence may have to be taken into account in order to ensure that the target analytes (i.e., chemical substances present in the environment) are reliably detected and quantified. Thus a practically useful sensor must have the ability to detect multiple analytes simultaneously. This can be achieved by multiplexing parallel sensor heads with differential sensitivities to the different analytes; for analytes whose concentrations in principle vary independently from each other, there should be at least as many sensor heads as there are analytes of interest, plus one or more reference sensors for physical variables such as temperature and the refractive index of the ambient medium, which may also affect the response of the sensor.

A component of the present invention is to endow the multiple optical fibres with different responsivities in two respects (i) and (ii) below.

The responsivity R_{A} is defined as the change in reflectance ΔR of the coated fibre end (i.e., the reactive film) upon exposure to a substance A at a particular concentration a₁, i.e.

R_{A}=ΔR/a₁ (equation 1)

Here it is assumed that prior to exposure, the concentration of A was zero. More generally, a₁ in equation (1) can be replaced by Δa, where Δa means a change in the concentration of a, e.g. from a₁ to a₂. Equation (1) represents a special case of linear response. More generally, the responsivity R is a function of the concentration and varies according to the starting concentration. The endowment is accomplished by (i) end-coating the fibres with different materials; each different coating (reactive film) will respond differently to different chemical substances. Furthermore, (ii) each coating of the collection of different materials will respond differently when exposed to the same chemical substance. In the simplest terms, considering just two differently coated fibres, F₁ and F₂, exposed to two substances A and B at concentrations a₁ and b₁, respectively,

R(F₁)=ΔR(F₁,a₁)/a₁+ΔR(F₁,b₁)/b₁)

R(F₂)=ΔR(F₂,a₁)/a₁+ΔR(F₂,b₁)/b₁) (equations 2)

where ΔR(F₁,a₁) is the change of reflectance of fibre 1 when exposed to substance A at concentration a₁, whence from measurement of the two responsivities, knowing the responsivities of the individual fibres to the individual pure substances as defined by equation (1), the two (unknown) concentrations a₁ and b₁ can be determined. Clearly this scheme can be generalized to any number of fibres and substances and where the responsivities become complicated nonlinear functions of concentration it may be that advanced numerical techniques are necessary to make the determinations. The precise way in which the sensed substances (which may be called “analytes”) change the reflectances is described later (equations 5 and 6).

The present invention addresses the needs described above by providing a sensor as defined in the claims. The fibre-optic sensor of the present invention is particularly attractive, since it neither engenders, nor is affected by, electromagnetic interference, which is an important consideration for devices carried on aircraft. Further, since an apparatus incorporating the sensor of the present invention need only be based on components that are easily miniaturized, such an apparatus occupies only a very small volume and has only a very small energy requirement in operation.

It should be appreciated that applications are by no means restricted to aircraft cabin air monitoring. Any kind of vehicle, including space stations and manned spacecraft, ships and submarines, as well as domestic and (agro)industrial spaces both indoors and outdoors, the latter including military bunkers, trenches and battlefields, and tunnels, and so forth, are all places in which the invention can be advantageously used. The apparatus can also be worn on the person in order to continuously monitor that person's environment.

In principle, any optically transparent material can be used for the optical fibre end-coating (reactive film). The material should interact in some way with the analyte such that the optical thickness of the material is altered. Such alteration may be embodied as an increase or decrease of the thickness of the coating of the material, or an increase or decrease of its refractive index, or any combination.

Nonporous materials, such as sucrose (sugar), NaCl (common salt) or silica (quartz), form atomically dense monolithic crystalline or amorphous phases. Sensors may be based on the use of such materials. Indeed, such an optical sensor is disclosed in GB 2428290 B and U.S. Pat. No. 7,876,447 B2 “Monofibre Optical Meter for Chemical Measurement”, the disclosures of which are hereby incorporated in their entirety. GB 2428290 B and U.S. Pat. No. 7,876,447 B2 describe a reactive film that interacts with an analyte; for instance, by being etched, dissolved or otherwise degraded by the analyte. The optical sensor of GB 2428290 B and U.S. Pat. No. 7,876,447 B2 relates to detection of changes in the chemical composition of a solution. A chalcogenide reactive film (optical fibre end-coating), such as a GeAs or an AsSe glass of 3-5 μm thickness initially, is described for use in sensing high pH, and an oxide glass for sensing low pH. These materials were designed for use in a liquid medium, in which the etched or dissolved material is transported away in the liquid.

Even if such materials react with the analytes of primary interest to the present sensor, namely gases, volatile organic compounds and semivolatile organic compounds in a gaseous medium, the reaction can take place only at the surface of the material. Furthermore, in many cases, the product of the reaction acts to stop further reaction. In such cases, changes in the optical path length (that is, the product of the refractive index and the geometric thickness of the film) will generally be minuscule and of little practical use for sensing purposes. A further limitation is that the reactive film is gradually and irreversibly consumed during the action of sensing, which limits the practically useful lifetime of the sensor, although it is advantageous for dosimetry. The present disclosure includes materials that are not irreversibly destroyed or inactivated by the action of sensing. The analytes are absorbed in the nanopores, and when the analyte is no longer present in the external medium, the absorbent material is released from the nanopores.

Hence, whereas according to the prior art the reactive film is nonporous, the present invention provides a nanoporous material (with connected porosity; i.e., there are channels connecting all pores to the external environment) for the reactive films of the optical fibres. The analyte can thus penetrate throughout the coating. This feature enormously increases the sensitivity. The porosity is preferably uniform, which confers enhanced selectivity onto the material, because its interaction with the analyte now depends not only on chemical reactivity but also on accessibility as a function of analyte size. In other words, since the analytes of interest differ in size, the nanoporous material preferably has uniform pores of a particular size, such that it can admit analytes of a corresponding size but not larger ones (size-dependent selection).

Furthermore, the nanoporous material may be a flexible nanoporous material. If the material were merely nanoporous, when analyte penetrated into the material in an unexposed state with the pores filled with air, the optical thickness would increase by virtue of the analyte replacing the air in the pores, the refractive index of the analyte being greater than that of air. “Flexibility” in this context means that the dimensions of the material change—usually increase—upon exposure to analyte, without necessarily any change in the bonding pattern of the material (although this may occur). If, in addition to the refractive index change of the material that occurs merely by filling its pores, there is also a dimensional change, the optical thickness will change far more significantly, which is the key to improving the sensitivity of the sensor.

Furthermore, by judiciously choosing the components from which the nanoporous material is constructed, specificity of interaction with analyte may be achieved not only by a size filtering effect, whereby analyte molecules larger than the pore are excluded, but also, in the case of hybrid inorganic-organic materials, including metal-organic frameworks, by ensuring that the metal moiety and/or the organic moiety specifically react with the selected analyte and not, or to a significantly lesser degree, with all other analytes.

Thus, the present invention provides a sensor having increased sensitivity and specificity for the detection of analytes and an improved robustness. Further, the sensor of the present invention provides enhanced flexibility and versatility in application, since the variety of available nanoporous materials is already very great and constant progress in understanding how to synthesize new ones is being made. It can be used to detect a very wide range of airborne analytes, including those in the form of gases, vapours and aerosols, while also able to detect analytes in liquid media.

As used herein, the term “nanoporous” means that the material is provided with a plurality of pores both on the surface of the material, and within the body of the material, which pores are less 100 nm in diameter. In an aspect, the diameter is less than 80 nm, preferably less than 60 nm, preferably less than 50 nm, preferably less than 40 nm, preferably less than 30 nm, or preferably less than 20 nm, or preferably less than 20 nm, or preferably less than 10 nm, or preferably less than 5 nm, or preferably less than 2 nm, or preferably less than 1 nm, or preferably less than 0.5 nm.

It will be appreciated that the geometry and size of the nanopores will vary between different types of nanoporous materials. For instance, some nanoporous materials may have nanopores that are shaped like cylinders, spheres, or more irregular voids. As used herein, the “diameter” of the nanopore refers to the smallest dimension of the nanopore, for instance, the diameter of a cylindrical nanopore, or the width of a slit-shaped nanopore at its narrowest point.

It will be appreciated that there may be variability in the diameters of the nanopores of a given material. Thus, in an aspect, where the diameters of the nanopores are stated to be less than of given value, it means that more than 50%, 60%, 70%, 80% or 90% (most preferably 90%) of the total number of nanopores have diameters less than said value. For instance, when the nanopore diameter is stated to be less than 10 nm, it may mean that more than 50% (or alternatively 60%, 70%, 80% or 90%) of the total number of nanopores have a diameter less than 10 nm. Furthermore, the diameters may have one or more definite sizes present simultaneously with their spatial positions defined by the atomic construction of the nanoporous material, if it is perfectly crystalline. In other cases, especially with nanoporous materials created from organic polymers, or those created from congeries of nanoparticles of porous or nonporous materials, both the sizes and the spatial positions of the interparticle pores may be random and their distributions defined statistically.

Nanopores having the diameters listed above are advantageous, in that they are sufficiently small so as to allow ingress of the analyte (that is, they have the ability to host analyte molecules within their interior), but at the same time not so large so as to excessively scatter light within the film, which would prevent the effective operation of the sensor. Furthermore, the pores are open to the exterior and thus allow the chemical substances diffusing in the ambient medium to enter the entire sensing medium.

Without wishing to be limited by theory, it is thought that an analyte can diffuse into the pores of the nanoporous material, changing the refractive index and/or thickness of the reactive film. The greater the change in thickness and/or refractive index of the reactive film upon interaction, the greater the change in signal from the end of the monofibre waveguide (the signal indicates the change in reflectance ΔR of the sensor, introduced in equation (1), which can be written as a function of the changes in thickness and refractive index of the reactive film). Nanoporous materials giving larger thickness and/or refractive index changes than nonporous materials therefore provide the sensor with improved sensitivity to analytes.

In an aspect, the nanoporous material may be inorganic. Nanoporous materials consisting of inorganic components can be characterized as inorganic nanoporous materials. Zeolites are examples of such inorganic nanoporous materials. These are well-known (both natural and artificial) crystalline inorganic materials, which naturally comprise cavities. The nanopores of zeolites are typically small, and in some cases only large enough to admit small gas molecules. Zeolites with such small pores may admit small gas molecules such as carbon monoxide, carbon dioxide and ozone, and may be of particular interest and relevance to aviation. It should, however, be noted that zeolites and other all-inorganic nanoporous materials are generally too rigid and are unlikely to change their dimensions upon exposure to an analyte. More recently, “organic zeolites” have been created, mimicking the natural silicaceous ones. These nanoporous materials, comprising organic components, can be characterized as organic nanoporous materials.

In another aspect, the nanoporous material comprises an organic polymer. Porosity of an irregular nature can be achieved using such organic polymers. In a further aspect, the organic polymer may be cross-linked. Such cross-linked polymers may be advantageous, in that the additional constraint of the cross-linkages may prevent efficient packing and thus provide enhanced nanopores in the gaps between polymer molecules. Nanoporous materials comprising an organic polymer are known in the art as “porous organic cages” or “polymers of intrinsic microporosity” (PIMs). As with the zeolites, for some such materials, the nanopores may be small, and thus suited for small-molecule analytes such as various gases. It should be noted, however, that the pores of PIMs and cross-linked organic polymers are not typically uniform in size.

In another aspect, the nanoporous material is made using the sol-gel process. In an aspect, the precursor materials are inorganic. In this aspect, the porosity may be enhanced using the molecular imprinting technique mentioned in the next paragraph, but when inorganic materials are created by gelling sols, the final material may in any case be nanoporous.

In another aspect, the nanoporous material is a hybrid organic-inorganic nanoporous material. There is a large class of hybrid organic-inorganic nanoporous materials, such as nanocomposites, in which organic and inorganic nanoblocks are self-assembled to form the final material. This allows the creation of much larger pores than those of the zeolites, and a tremendous variety of structures and chemistries is achievable. In an aspect of these hybrid materials, the nanoporous material comprises a metal-organic framework (MOF). Like zeolites, MOFs are also nanoporous materials. If the nanoporous is described as a lattice (scaffold) with vertices joined by edges (in the language of graph theory), the MOFs are characterized by metal vertices (nodes) and organic edges (linkers), in place of the inorganic linkers of the inorganic crystalline porous solids like the zeolites. Very wide choice is available for both the metal nodes (which may be single atoms or clusters of atoms) and the organic linkers, which combination gives rise to a tremendous variety of MOFs. Compared to inorganic porous solids such as zeolites, MOFs have far greater structural and chemical diversity, depending on the natures of both the metal and the organic linker. MOFs exhibit a wide range of nanopore sizes and chemical reactivities, a range greater than that achievable with the all-inorganic materials. Further, MOFs may exhibit adaptive behaviour with respect to guest analytes, whereby the MOF itself undergoes a physical change upon interaction with an analyte. For example, a MOF may undergo structural deformation following influx of an analyte.

The metal-organic framework (MOF) materials are thus hybrid organic-inorganic nanoporous materials, typically with a well-defined, crystalline structure and with uniform pores.

In an aspect, the nanoporous material is crystalline. In another aspect the nanoporous material is polycrystalline. In another aspect the nanoporous material is amorphous.

In another aspect the nanoporous material is flexible, or soft, or compliant, which may mean that the nanoporous material is expandable, or shrinkable. In an aspect, the nanoporous material has a Young's modulus, preferably in at least one direction, of less than 10, 5, 4, 3, 2 or 1 GPa. The Young's modulus, preferably in at least one direction, may be less than 1 GPa. The elastic properties of a flexible nanoporous material may be anisotropic, and it may be useful for the invention if the flexible nanoporous material has a low Young's modulus in at least the direction parallel to the longitudinal axis of the monofibre waveguide, for instance, less than 10 GPa, or less than 1 GPa. The degree of flexibility can also be defined as a percentage change in at least one unit cell parameter (or unit cell dimension) following the ingress of an analyte into the nanoporous material. Preferably, the material is and remains crystalline during such ingress. The unit cell parameter (or unit cell dimension) changes may be determined by X-ray diffractometry in the absence and presence of the analyte. In an aspect, at least one unit cell parameter (or unit cell dimension) of the nanoporous material will change by at least 2%, 5%, 10%, 20% or 30%. Preferably, the parameter (or dimension) changes by at least 10%, 20% or 30%.

In another aspect the flexibility of the nanoporous material manifests itself in a volume increase of the pores during ingress of the analyte. This volume increase may effectively be achieved by structural changes that lead to hitherto inaccessible pores becoming accessible to the analyte. In an aspect, the volume increase is at least 10%, 20%, 50%, 100%, 200% or 300%. Preferably, the volume increase is at least 20%. More preferably the volume increase is at least 100%.

In an aspect the nanoporous material is provided as a plurality of particles, each particle individually being crystalline or polycrystalline. Each of the particles may have a defined particle size. In one aspect, the particle size is defined as the longest dimension of the particle. In one aspect, “plurality” means there is more than one particle. In another aspect “plurality” comprises particles formed from mixtures of different materials. The final film is then fabricated by assembling the particles. The material then has interparticle nanopores. If the particles are individually nanoporous, then the material also has intraparticle nanopores.

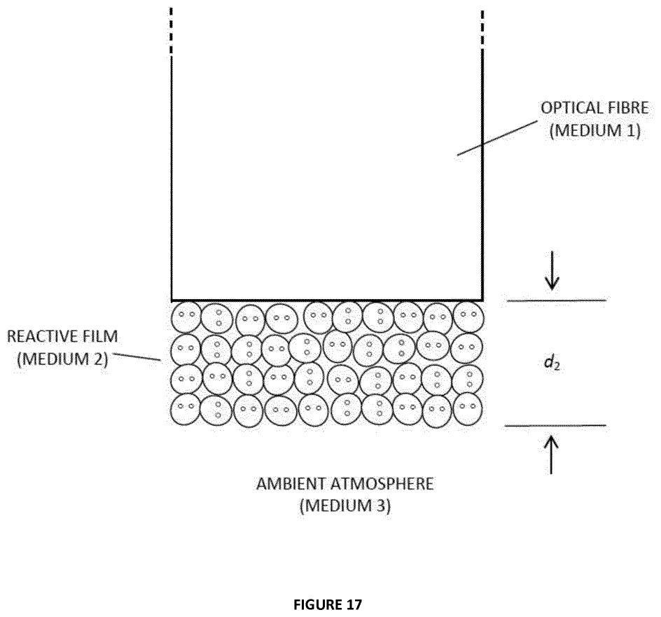

FIG. 17 illustrates a reactive film formed from a plurality of nanoporous nano-objects.

It will be appreciated that where the size of each particle is different, there will be a distribution of the particle sizes, and a distribution of the intraparticle pore sizes.

In an aspect, the average particle size is less than 160, 180, 200, 250, 300, 350, 400, 500 or 1000 nm. Preferably, the average of the particle sizes is less than 120, 140 or 150 nm. More preferably the average of the particle sizes is less than 20, 40, 50, 60, 80 or 100 nm.

In another aspect, the mode of the particle size is less than 160, 180, 200, 250, 300, 350, 400, 500 or 1000 nm. Preferably, the mode of the particle sizes is less than 120, 140 or 150 nm. More preferably the mode of the particle sizes is less than 20, 40, 50, 60, 80 or 100 nm.

In another aspect, the median of the particle size is less than 160, 180, 200, 250, 300, 350, 400, 500 or 1000 nm. Preferably, the median of the particle sizes is less than 120, 140 or 150 nm. More preferably the median of the particle sizes is less than 20, 40, 50, 60, 80 or 100 nm.

In another aspect, at least 80% by weight of the particles have a particle size that is less than 160, 180, 200, 250, 300, 350, 400, 500 or 1000 nm. Preferably, at least 80% by weight of the particles have a particle size that is less than 120, 140 or 150 nm. More preferably at least 80% by weight of the particles have a particle sizes is less than 20, 40, 50, 60, 80 or 100 nm.

It has been found that a nanoporous material having the particle sizes above is advantageous when used for the reactive film of a sensor. This is particularly so when the nanoporous material is a MOF.

It will be appreciated that the reactive film can comprise more than one type of nanoporous material (i.e., a mixture). However, it is preferred that the reactive film on any individual fibre comprises one type of nanoporous material.

In another aspect, the nanoporous material may be a congeries of nano-objects. The growing availability of well-defined nano-objects such as nanoparticles or nanofibres or nanoplatelets has enabled a further class of nanoporous materials to be realized, namely by agglomerating or aggregating the nano-objects. Precise tuning of the overall characteristics of the assembly can be achieved by tuning the distribution of sizes of the agglomerated particles, as well as their chemistries. Very often the agglomeration occurs spontaneously upon concentrating the particle suspension, as happens, for example, during the dip-coating process.

In another aspect, the nanoporous material may be prepared by combining the various classes of materials described above. For example, a nanoporous material may be prepared by combining a zeolite, a polymer, and/or a MOF, and agglomerating them to generate a nanoporous material having more than one class of nanopore (for instance, interparticle nanopores and intraparticle nanopores).

In yet another aspect, the method of alternating polyelectrolyte deposition (APED) may be used to build up coatings. The polyelectrolytes can be chosen from organic polyions and nano-objects with ionizable surface groups. Thus, this process constitutes yet another way of fabricating hybrid organic-inorganic materials. In a particularly useful aspect, one polyelectrolyte is a nanoporous particle and the other polyelectrolyte is an organic-polymeric polyanion. The latter is then able to agglomerate the particles in order to form a film.

Where the nanoporous material is a MOF, the reactive film can be built up layer-by-layer (LbL) by alternately exposing the film substrate to the metal node moiety and to the organic linker moiety that are combined to create the MOF. This method is often called “liquid phase epitaxy” (LPE).

Where nano-objects are required for reactive film fabrication, they may be prepared by nucleation and growth of the compound from appropriate precursors, or by comminuting already-synthesized material of larger size.

In an aspect, the optical monofibre waveguide is substantially transparent to an electromagnetic radiation having a wavelength in the ranges of visible light (such as 400 nm to 700 nm), UV light (such as 10 nm to 400 nm) or infrared radiation (700 nm to 1000000 nm). As used herein, the term ‘substantially transparent’ to an electromagnetic radiation having a given wavelength means that the optical monofibre waveguide permits sufficient transmission of said radiation through it to allow the analyte-specific signal to be usefully distinguished from the noise. In an aspect the term means that the optical monofibre waveguide permits more than 50%, 60%, 70%, 80%, 90% and most preferably more than 95% of said radiation through it to allow the analyte-specific signal to be usefully distinguished from the noise. It will be appreciated that the transmission through the very short (typically less than a few micrometres and unlikely to exceed 1 millimetre) reactive film can be far lower (when expressed as attenuation per unit length) than the transmission through the rest of the fibre between the reactive film and the light source and detector, which may be many metres long.

In an aspect, the monofibre waveguide comprises silica. In another aspect, the monofibre waveguide comprises a silver halide (such as chloride, bromide, or iodide) or silver phosphate. In another aspect, the monofibre waveguide comprises an arsenic chalcogenide (such as sulphide, selenide or telluride). In another aspect, the monofibre waveguide comprises a metal or metalloid oxide (such as hafnia, niobia, selenia, silica, tantala, titania, tungsten or zirconia). In another aspect, the monofibre waveguide comprises an element such as silicon. In another aspect, the monofibre waveguide comprises a ternary compound (such as barium titanate, or zirconium barium fluoride). In other aspects, quaternary (such as zirconium barium lanthanum fluoride), quinary (such as zirconium barium aluminium sodium fluoride) or more complex compounds (which may be solid solutions; for example, zirconium barium fluoride may be considered as a solid solution of zirconium fluoride in barium fluoride) may be employed. In another aspect, the monofibre waveguide may be made from an organic polymer.

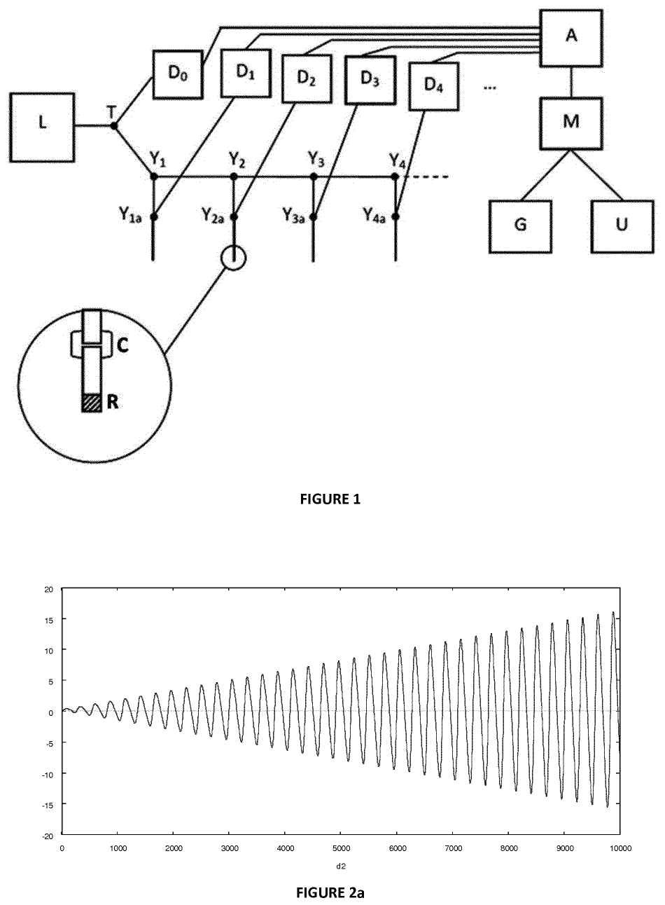

In an aspect, the optical fibre is continuous and uniform in composition from the last coupler or splitter (cf. FIG. 1) up to the distal end that is coated. In another aspect, a short (typically millimetres or centimetres) stub is connected to the end of the fibre coming from the last coupler or splitter (cf. FIG. 1); this stub may be from the same or a different material chosen from the halides, chalcogenides, oxides and so forth described above; it is this stub that is end-coated with the nanoporous material to form the reactive film for capturing the analyte.

The monofibre waveguide may comprise a longitudinal axis.

In an aspect, the optical fibre can be single mode, because it is desired to measure the interference between two coherent reflexions, one from the interface between the distal end of fibre and the reactive film, and one from the interface between the reactive film and the ambient environment, the two interfaces being parallel to each other.

The present invention is particularly advantageous when used to detect toxic, or possibly toxic, compounds in the air, such as in aircraft cabin air during a fume event.

In an aspect, the present invention provides an apparatus for detecting an analyte in a medium, the apparatus comprising a sensor comprising a monofibre waveguide and a reactive film that, in use, is placed in contact with a medium (such as the ambient air), such that, in use, interference representative of the presence of the analyte is produced due to reflexions at an interface between the monofibre waveguide and the reactive film and an interface between the reactive film and the medium, wherein the reactive film comprises the nanoporous material. If the reaction of the reactive film with the analyte is gradual, an interference pattern (interferogram) will be generated in time. The typical form of an interferogram is a sinusoidal curve possibly varying in amplitude and frequency.

An optical sensor, such as that described in GB 2428290 B and U.S. Pat. No. 7,876,447 B2 “Monofibre Optical Meter for Chemical Measurement”, the disclosures of which are hereby incorporated in their entirety, is an optical sensor that can be modified for use with the present invention. GB 2428290 B and U.S. Pat. No. 7,876,447 B2 disclose a bundle of monofibres having reactive films placed on their distal ends. These reactive films may interact with an analyte, thereby changing the reflectances of the fibre ends. Differently coated fibres may manifest different reflectance changes in the presence of the same chemical substance. At the same time, different chemical substances may cause any given fibre to manifest different changes in reflectance. Simultaneously monitoring the changes in reflectances over time enables the identity and concentration of one or more analytes to be determined (cf. Equations 1 & 2). (The example given in the previous patents concerned the measurement of pH in aqueous media.)

Both GB 2428290 B and U.S. Pat. No. 7,876,447 B2 describe multiplexing of sensors. The primary signals of interest are expected to be achieved using multiple single mode (monomode) fibres. However, the sensor heads used for referencing (cf. GB 2428290 B and U.S. Pat. No. 7,876,447 B2)—that is, determining background physical parameters such as temperature and refractive index of the medium—may also use multimode fibres and operate in simple reflexion mode rather than generating interferograms.

The present invention, by use of the nanoporous material, enhances the performance of the sensor of GB 2428290 B and U.S. Pat. No. 7,876,447 B2, by allowing for measurement of very small concentrations of analytes especially in gaseous media. These analytes may be present as gases, vapours or, in the case of substances with a relatively high boiling point (e.g., the so-called semivolatile organic compounds), as an aerosol. Furthermore, the enhanced sensitivity and concomitant rapid response enables, in many cases, the instantaneous determination of analyte concentration to be carried out, which is especially important when it is desired to alert the user to the sudden appearance of a substance in the environment. The present invention allows for this by the use of a plurality of nanoporous materials for creating the reactive films placed on the distal ends of the optical fibres. Whereas in the sensor of GB 2428290 B and U.S. Pat. No. 7,876,447 B2 the analyte only reacted with the outermost surface of the film, with the present invention, the use of the nanoporous materials enables the analyte to react simultaneously within the entire volume (and entire internal surface) of the film, changing its optical properties to a correspondingly far greater extent than with solely outermost surface reaction. Furthermore, the use of flexible nanoporous materials ensures that not only are the pores filled with analyte, changing the refractive index of film, but also that the pores themselves expand, accommodating more analyte than otherwise, and the thickness of the film is also increased, upon exposure to the analyte or analytes.

The sensor of the present invention thus comprises a reactive film, the thickness and/or refractive index of which changes in the presence of the analyte to be detected.

Light travelling along the fibre and arriving at the tip (i.e., distal end) of the monofibre waveguide then exhibits interference due to reflexions at an interface between the monofibre waveguide and the reactive film (end-coating) interfering with reflexions at an interface between the reactive film and the ambient medium. The changes in thickness and/or refractive index in the presence of the analyte lead to changes in the interference, thereby allowing detection of the analyte via appropriate signal processing.

If the change in analyte concentration in the ambient medium is instantaneous and the resulting change in the thickness and/or refractive index of the reactive film is instantaneous, then the optical signal change is also instantaneous. On the other hand, if the change in analyte concentration is gradual, and/or the change in the thickness and/or refractive index of the reactive film as a result of its interaction with the analyte is gradual, the optical signal change is also gradual and will trace out a sinusoidal interference pattern (interferogram).

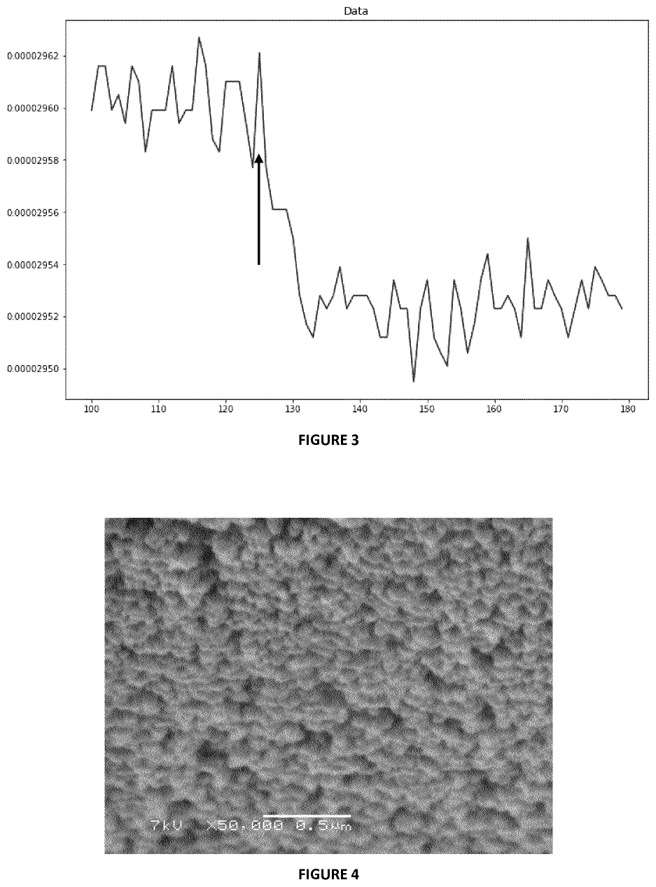

Operation of the sensor involves recording the signal change taking place as a result of the changes of the reactive film thickness d₂ and/or the refractive index n₂ of the reactive film due to interaction of the film with the medium containing the analyte. For a reference monofibre lacking a reactive film, the optical signal change is a simple consequence of the change of Fresnel reflectance at the interface between the optical fibre and the ambient medium (see FIG. 3). If the thickness of the film is greater than the coherence length of the light source, it is likewise appropriate to regard the optical signal change as a simple consequence of a change in Fresnel reflectance at the interface between the optical fibre and the film.

The output voltage V (or output current A) of the detector depends linearly on the power of the radiation P_{R} reflected back from the distal end of fibre, which is in contact with the analyte:

V=κP_{R} (equation 3)

where κ is a constant of proportionality depending upon the optoelectronic parameters of the measurement setup. The reflexion coefficient R is defined as the ratio of incident and reflected powers:

R=P_{R}/P₁, (equation 4)

the incident power P₁ may be measured by a separate photodiode (see FIG. 1). R is a material property that depends only on the fibre parameters, i.e. for an uncoated fibre

R₁₃=[(n₁−n₃)/(n₁+n₃)]² (equation 5)

where n₁ and n₃ are the refractive indices of the monofibre waveguide (indicated by subscript 1) and the medium surrounding its end (indicated by subscript 3), respectively. Hence, if the refractive index of the medium suddenly changes (e.g., due to the ingress of analyte) there will be change in the reflectance (see FIG. 3).

The medium may be a gas or a liquid. The medium is preferably a gas, such as air. If the incident power is unknown, the proportionality constant K can be determined from the response from a medium of known refractive index via equations 5, 4 & 3, assuming n₁ is known, otherwise the responses from two media of known refractive indices need to be measured.

In the case of an optical fibre end-coated with a thin (reactive) film of thickness less than the coherence length of the light source we have an interference system and equation (5) is no longer applicable but instead we have the coefficient of reflexion R₁₂₃, taking account of the multiray interference of the light beams reflected from the two boundaries of the deposited film (considered as a homogeneous medium indicated by subscript 2 located between two homogeneous media of differing refractive indices):

$${R}_{123} = \frac{\begin{matrix}( {n}_{3}^{2} + {n}_{2}^{2} ) ( {n}_{2}^{2} + {n}_{1}^{2} ) - \\ 4 {n}_{3} {n}_{2}^{2} {n}_{1} + ( {n}_{3}^{2} - {n}_{2}^{2} ) ( {n}_{2}^{2} - {n}_{1}^{2} ) cos 2 β\end{matrix}}{\begin{matrix}( {n}_{3}^{2} + {n}_{2}^{2} ) ( {n}_{2}^{2} + {n}_{1}^{2} ) + \\ 4 {n}_{3} {n}_{2}^{2} {n}_{1} + ( {n}_{3}^{2} - {n}_{2}^{2} ) ( {n}_{2}^{2} - {n}_{1}^{2} ) cos 2 β\end{matrix}} \qquad ( equation 6 )$$

where n₂ is the index of refraction of the reactive film, and

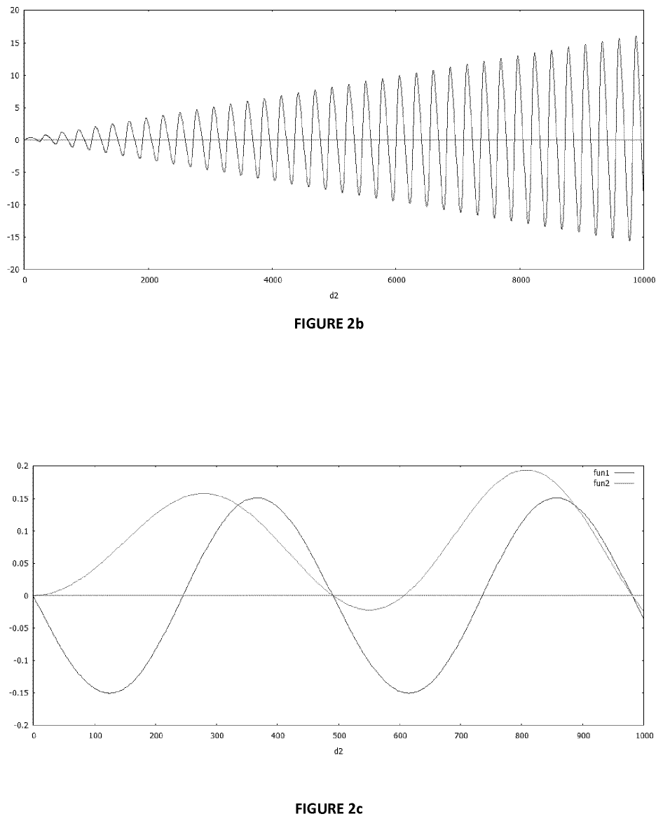

β=2πn₂d₂/λ (equation 7)

where d₂ is the thickness of the reactive film, and λ the wavelength emitted from the light source. FIGS. 2a, 2b, 2c shows how the thickness of the reactive film should be adjusted to maximize the sensitivity (responsivity) of the device. From equations (6) and (7) it can be seen that the sensitivity of the response towards different concentrations of analyte, engendering different changes in n₂ and d₂, depends on the material properties of the system, especially the indices of refraction and thickness of the reactive film.

The dynamics of change of the concentrations of the experimental solutions under investigation should also be considered. Equations (5) and (6) also show how the temporal rate of change of R₁₂₃, dR₁₂₃/dt, will depend on the rate of change of the reactive film thickness, dd₂/dt, (and, ceteris paribus, the rate of change of the reactive film refractive index) which may depend on the nature of the analyte(s) and its (their) concentration(s) as well as any time dependencies of the concentration(s). These coefficients can be conveniently determined by following the time dependence of the coefficient of reflexion.

Thus, the present invention functions by analysing the changes in the refractive index and/or thickness of the reactive film occurring as a result of an interaction between an analyte and the reactive film. For any given reactive film, characterized by a particular chemical and geometrical nature as well is by its overall thickness and refractive index, the nature and concentration of analyte affects the magnitude of the change and/or rate of change.

In an aspect the sensor may comprise a Y-type distributor that divides radiant power from a power source between an input channel and an output channel. From the input channel the radiation propagates into a common channel, the end of which is to be placed in contact with the medium. The optical signal is reflected (in a complex fashion involving interference, as described above) from the interface with the medium and returns into the common channel. The signal propagates from the common channel into the output channel from which the signal is amplified and processed.

Once we have the value of ΔR₁₂₃, or dR₁₂₃/dt, and assuming that λ is known and that the other parameters in equations (6) and (7), viz. n₁ and n₃, are either known or determined from the reference monofibre(s), we can then proceed to determine the analyte concentration.

The simplest case is perhaps that of the nanoporous material with rigid pores all accessible from the external environment and occupying a fraction θ of the total volume of the film. This fraction includes both intra- and inter-particle pores. We might use an effective medium approximation (EMA) to determine the film refractive index, for example the parallel approximation, viz.

n₂=nₚₒᵣₑθ+nₘₐₜₑᵣ(1−θ) (equation 8)

where nₚₒᵣₑ is the refractive index of the pores—initially filled with air—and nₘₐₜₑᵣ is the refractive index of the nanoporous material in monolithic form (i.e., without pores)—it is assumed that this is known, possibly through calculation if the precise structure and composition of the material is known, otherwise through measurement. When contamination—i.e., analyte—is present in the air, the pure air in the pores will be displaced by the analyte-containing air, which will have a different refractive index from that of pure air, hence n₂ will change according to equation (8). Preferably, the affinity of the analyte for the nanoporous material will exceed the affinity of air for the nanoporous material, such that the air is chased out of the pores. In some cases, where sufficient information is available, including the thermodynamic affinity of the analyte for the pore material, the concentration of the analyte in the pores for any given external analyte concentration can be calculated. Whether or not this is possible, in every case the change in n₂ with analyte concentration can be determined empirically via equations 6, 7 and 8. For this, we also require d₂. If the coating procedure is well enough understood and controlled, d₂ will be determined by the parameters of the procedure. In other cases it may be measured independently using ultramicroscopy (e.g., scanning electron microscopy or atomic force microscopy), or by any other convenient method.

The change in n₂, derived from the change in R₁₂₃, can then be related to the change in nₚₒᵣₑ, which may be given by:

nₚₒᵣₑ=nₐᵢᵣxₐᵢᵣ+n_{analyte}x_{analyte} (equation 9)

where the x denote mole fractions, which sum to unity, hence in this case xₐᵢᵣ=1−x_{analyte}. Since both nₐᵢᵣ and n_{analyte} are known, x_{analyte}, which is the goal of the measurement, can then be found.

The above assumes that d₂ does not change during reaction of the analyte with the film. In the most favourable case of variation of n₂, the analyte vapour condenses in the nanopores and analyte equals the refractive index of the pure liquid. If it does, the principle remains the same but the calculations become more complicated. If they become intractable, and in any case if any of the parameters required for the calculations are unknown, it will always be possible to calibrate the sensor by measuring its responses to a succession of different analyte concentrations; i.e. using equations 3, 4 and 1. In other words, the responsivity is simply determined empirically rather than through calculation making use of material parameters.

In the case of flexible, soft or compliant films, the thickness changes (increases or decreases) upon penetration of the analyte into the nanoporous material. In the case of anisotropic change, the material is preferably oriented such that the direction of greatest change is parallel to the longitudinal axis of the optical fibre.

In general, the most relevant parameter is the change in the coefficient of reflexion R₁₂₃ with ambient analyte concentration a, namely the coefficient dR₁₂₃/da. This can be written as:

dR₁₂₃/da≈(∂R₁₂₃/∂n₂)(dn₂/da)+(∂R₁₂₃/∂d₂)(dd₂/da) (equation 10)

The two coefficients ∂R₁₂₃/∂n₂ and ∂R₁₂₃/∂d₂ are plotted together on FIG. 2c. For a film thickness of 200 nm their values are comparable (albeit of opposite sign). As an example of a nanoporous material, let us take a typical MOF with nₘₐₜₑᵣ=2.0 and porosity θ=0.7. When the pores are filled with air (refractive index=1.000274), then n₂=1.30019. If the pores are filled with saturated ethanol vapour, n₂ increases to 1.30023, an increase Δn₂ of 0.00004. On the other hand, if the MOF is flexible and the thickness increases by 30% in the presence of ethanol, Δd₂=0.06 μm. Hence, the change in reflectance will be 1500 times greater than if the MOF were not flexible and could only respond by changing the filling of its pores.

If the affinity between the target analyte and the nanoporous material comprising the reactive film is small, when the analyte disappears from the ambient medium, it will diffuse out of the pores of the reactive film and the reflectance will revert to its original value. This may be desirable for the sensing mode of operation (cf. FIGS. 12, 14 and 16).

If, on the other hand, the affinity between the target analyte and the nanoporous material comprising the reactive film is very high, such that the analyte essentially interacts irreversibly with the film, when the analyte disappears from the ambient medium, it will remain in the pores of the film. This may be desirable for the dosimetric mode of operation, in which the accumulated dose is recorded. The affinity between the target analyte and the nanoporous material comprising the reactive film is determined by the chemical nature of the nanoporous material, for any given analyte. In some kinds of nanoporous material, structure and analyte affinity are strictly fixed. In others, most notably the metal-organic frameworks, the metal and/or organic linker can be considerably varied or modified in order to change affinity without changing pore structure.

If the diffusion of the analyte is very slow, after it has fully penetrated into the pores of the nanoporous material, if the ambient concentration then falls to zero, the diffusion of the analyte out of the nanoporous material will be likewise very slow, even if the affinity between the analyte and the nanoporous material is small.

As well as choosing the chemical nature of the nanoporous material, which determines the affinity to the analyte, the size of the pores will also confer selectivity, smaller pores obviously excluding larger analytes.

In some cases, especially with the hybrid organic-inorganic materials, in which the inorganic nodes are linked with flexible organic linkers, “breathing” modes of interaction are known, in effect making θ (equation 8) dependent on the analyte concentration. “Breathing” may also cause d₂ to vary with x_{analyte}. Any case, no matter how complex, can in principle be dealt with by the approach outlined above, provided the essential features of the system are captured by appropriately elaborated equations derived from equations 8 and 9.

If the affinity of the analyte for the pore material is very high, the analyte may coat the inner surfaces of the pores leaving their lumens filled with air. In such cases equation 9 must be modified accordingly.

In the cases of reactive films assembled from congeries of nano-objects, apart from the one or more types of pores within the nano-objects, there are also “pores”—i.e., voids—between the nano-objects. These can also be dealt with using equations 8 and 9; in reality θ needs to be subdivided into multiple different types of pores, differing in both size and chemical functionality. While in principle the system remains fully determined, in practice we may not know the values of the multiple θs and their affinities. Heuristically we can then replace θ in equation 8 by θ*—an effective pore or void fraction—and associate it with other effective quantities, such as effective affinity for an analyte. Whether or not we can precisely link these effective quantities with chemical and structural quantities of the nanoporous material does not affect our ability to determine the concentration of analyte in the ambient medium from the measured change in optical reflexion from the fibre end.

An example of a device is shown in FIG. 1 comprising a radiation source L. A suitable radiation source is a laser diode, but other radiation sources may be used. If interference is being exploited using equations 6 and 7, the coherence length of the light source must exceed the thickness of the reactive film. Any wavelength of radiation in the ultraviolet, visible or infrared spectral regions is suitable. The useful part of the infrared region may range from 800 to 1600 nm, preferably 900 to 1550 nm, such as 0.95 μm, or 1.31 μm, or 1.55 μm. The radiation source is connected to a Y-shaped monofibre waveguide that is coated with a reactive film R at its tip (distal end). The coated tip may be placed in a medium 3. When the radiation propagates along the monofibre waveguide and is reflected back from the fibre end, the reflected light passes to a photodiode D. The signal then passes to an analogue-to-digital converter (ADC). Pre- and post-amplifiers may be included in the circuit. The intensity of the radiation may be modulated in order to exploit lock-in detection in order to enhance the ratio of signal-to-noise. The signal from the ADC is then passed to a computer for information processing.

In another aspect, the device may comprise more than one optical fibre. The sensor may comprise two, three, four, five, six, seven, eight, nine, ten or more optical fibres. In this aspect, each of the reactive films of the fibres comprises a different nanoporous material, thus allowing the measurement of an increased number of analytes simultaneously (equations 2 and FIG. 1). Alternatively, more than one or all the reactive films of the fibres may comprise the same nanoporous material, which may advantageously improve the signal and sensitivity.

The device may include one or more uncoated reference monofibre waveguides to allow the bulk refractive index of the medium in which the analytes under investigation are dispersed to be measured. Hence, as well as functioning as a chemical sensor, the device may also function as a physical sensor to measure a parameter such as temperature, making use of the significant temperature coefficients of refractive index of many materials.

In an aspect the present invention provides a method of manufacturing a sensor comprising a monofibre waveguide having a reactive film at the distal end of the fibre, wherein the reactive film comprises a nanoporous material, the method comprising: providing the monofibre waveguide, and depositing the nanoporous material on the monofibre waveguide to form the reactive film.

In an aspect, the reactive film may be deposited either by physical vapour deposition or chemical vapour deposition.

In another aspect, a reactive film comprising a metal-organic framework material may be synthesized in situ by immersing the monofibre waveguide into a solution of the metal moiety and the organic moiety of the framework. The solution is preferably freshly prepared.

In another aspect, a reactive film comprising a metal-organic framework material may be synthesized in situ by alternately immersing the monofibre waveguide into a solution of the metal moiety and into a solution of the organic moiety of the framework. This method is known as liquid phase epitaxy (LPE). The alternating deposition continues until the required thickness of the reactive film is achieved.

In another aspect, the method comprises providing the nanoporous material as a plurality of nanoparticles (where nanoparticles are defined as nano-objects having all 3 dimensions within the nanoscale—that is, less than 100 nm), and depositing (i.e., letting adsorb) the plurality of particles on the monofibre waveguide to form the reactive film.

In another aspect, the method comprises providing the nanoporous material as a plurality of nanofibres, which are defined as nano-objects having two dimensions within the nanoscale, which is defined as less than 100 nm. If the fibres are hollow they are referred to as nanotubes. The plurality of nanofibres is deposited on the distal end of the monofibre waveguide to form the reactive film.

In another aspect, the method comprises providing the nanoporous material as a plurality of nanoplatelets, defined as nano-objects having one dimension within the nanoscale, and depositing the plurality of platelets in the monofibre waveguide to form the reactive film.

In another aspect, the plurality of nanoparticles, nanofibres or nanoplatelets are made from a material other than a nanoporous material.

In another aspect, a mixture of the different shapes may be deposited.

In another aspect, the nano-objects may be partly agglomerated or aggregated prior to deposition.

The plurality of particles may be provided in a suspension. The fluid phase of the suspension may be a gas, but it is preferably a liquid. When the suspension comprises a liquid phase, it is preferably kept in a vessel, which may be open to the environment, and the liquid may have an interface with the environment (which may be a gas). The liquid may be an aqueous solution, an inorganic solvent, or an organic solvent. The liquid may be water. The liquid is preferably an organic solvent. Where the nanoporous material is hydrophilic, the liquid phase of the suspension is preferably an aqueous solution or water. As used herein, the term hydrophilic means that the value of the interfacial free energy of the system [nanoporous material (or other material from which the film is to be made)−water−nanoporous material] is greater than zero.

To effect the deposition, the distal end of the fibre is immersed into the liquid suspension. The distal end is then withdrawn from the liquid and held in the atmosphere until all the solvent has evaporated. If a greater thickness of the reactive film is desired, the process of immersion and drying may be repeated ad libitum. In this aspect, the longitudinal axis of the monofibre waveguide is substantially perpendicular to the suspension interface with the environment. As used herein, the term “substantially perpendicular” means that an angle between the longitudinal axis of the monofibre waveguide and the interface of the suspension is 45° or greater. In an aspect, the angle is greater than 50°, 60°, 70°, 75°, 80°, 85° or 89°. In an aspect the angle is 90°. The angle is preferably greater than 75°, 80°, 85° or 89°. When immersed, the monofibre remains in position for at least one second and preferably more than 10, 100, 1000 or 10,000 seconds before withdrawing it from the suspension. In this aspect, the cycle of immersion and withdrawal may be repeated at least once, twice, thrice, four time, five times, six times or more. This method is known as spontaneous adsorption or assembly from solution or suspension.

In another aspect, when likewise the suspension comprises the nano-objects in a liquid phase, the monofibre waveguide is lowered through the suspension interface with the environment with the longitudinal axis of the monofibre waveguide being substantially parallel to the interface. As used herein, the term “substantially parallel” means an angle between the longitudinal axis of the monofibre waveguide and the suspension interface with the environment is 45° or less. In an aspect, the angle is less than 40°, 30°, 20°, 15°, 10°, 5° or 1°. In an aspect the angle is 0°. The angle is preferably less than 15°, 10°, 5° or 1°. Once the end of the monofibre is completely immersed in the suspension, the direction of travel is reversed and the monofibre is then raised with as smooth a motion as is practically possible, at a speed that is preferably less than 0.4 mm/s. The raising continues until the end of the monofibre, and preferably the entire monofibre, is completely detached from the suspension. This method is commonly known as “dip-coating”. By changing parameters such as the speed of raising, the concentration of nano-objects in the suspension, and the nature of the liquid, as well as the temperature of the entire operation in order to change the viscosity of the suspension and the rate of liquid evaporation, the thickness and density of the coating can be controlled. In an aspect, the cycle of lowering and raising is repeated at least once, twice, thrice, four time, five times, six times or more. Whenever there is repetition, the monofibre is held in air above the suspension long enough to allow the liquid to evaporate. In another aspect, a stream of hot air, at a temperature exceeding the boiling point of the liquid by preferably more than 50° C., 100° C., 150° C. or 250° C. (but not so great as to decompose the nanoporous material), is directed onto the freshly deposited film in order to accelerate liquid evaporation. The time required for the evaporation depends upon the nature of the liquid, the temperature, and some other parameters such as the velocity of the air with respect to the monofibre, and the relative humidity of the air. This method is also known as evaporation-induced self-assembly (EISA).

It has been found that, where the monofibre waveguide is immersed in the suspension of nano-objects with the longitudinal axis of the monofibre waveguide either substantially perpendicular or substantially parallel to the suspension interface with the environment, the reactive film is provided with a substantial fraction of interparticle voids, i.e. the nano-objects are arranged with a substantial amount of voids between them. Without wishing to be limited to theory, these voids greatly facilitate access of analyte to the internal pores of the nanoporous materials, and may also improve the size-selective admission into the pore and chemical affinity-driven selective binding of the analyte to the interior of the nanoporous materials. If the nano-objects are not themselves intrinsically nanoporous, the interparticle voids confer nanoporosity onto the reactive film. The actual geometry of the arrangement of the nano-objects with respect to each other ranges from random (as in random sequential assembly), when the particles have no other interaction between themselves other than hard body ones, to directed assembly, when the particles preferentially interact with each other, the available interactions comprising adhesion or repulsion, at particular sites on their surfaces.

In an aspect, where the suspension comprises an aqueous liquid phase, the suspension has a pH. In an aspect, the pH of the suspension is adjusted to a value between the pKa of the nano-objects, and the pKa of the end of the monofibre waveguide. The pH may be adjusted by adding an acid or alkali as appropriate. The suspension may further comprise a pH buffer. By adjusting the pH of the suspension to a value between the two pKas, it is possible to ensure that the electrostatic charges of the nano-objects and the monofibre waveguide are opposite to each other, thereby advantageously improving deposition of the nano-objects onto the monofibre waveguide by ensuring the presence of an additional adhesive force, namely electrostatic or coulombic attraction.

In an aspect, prior to the step of immersing the monofibre waveguide in the suspension, the method may further comprises the step of contacting the monofibre waveguide with an aqueous solution of a polyionic compound. The polyionic compound is preferably organic. The electrostatic sign of the polyion should be opposite to that of the nano-objects at the chosen pH of preparation. Thus, for negatively charged nano-objects, a polycation should be chosen. The polycation may be polyallylamine. For positively charged nano-objects, a polyanion should be chosen. The polyanion may be polyacrylate. Upon contact, the polyionic polymer spontaneously adsorbs on the fibre end. This step advantageously provides the distal end of the monofibre waveguide with a precoating that facilitates the deposition of the nano-objects onto the monofibre waveguide.

In a further aspect, after precoating the monofibre waveguide with an appropriate polyion, and then in turn coating with the nano-objects, coating with the polyion may be repeated, followed by another coating with the nano-objects, and this cycle of coatings may be repeated ad libitum to build up a film of any desired thickness. This method is known as “alternating polyelectrolyte deposition” (APED).

In a further aspect, after precoating the monofibre waveguide with an appropriate polyion, and then in turn coating with one type of nano-object, the monofibre waveguide is immersed in a suspension of another type of nano-object bearing an electrostatic charge of opposite sign to that of the first type, after which the monofibre waveguide is again coated with the first type, and then the other type, and so on ad libitum.

Whenever the method of APED is used, rinsing with pure suspending liquid may be interspersed between coatings with the nano-objects or other polyion.

In further aspect, the monofibre waveguide is coated with an organic polymer of intrinsic microporosity (PIM). This is achieved by dissolving the polymer in an appropriate organic solvent and immersing the distal end of the optical fibre into the solution, waiting for preferably at least 1 second, or at least 10 seconds, or at least 100 seconds, or at least 1000 seconds, or at least 10,000 seconds. During that interval the polymer adsorbs onto the surface of the monofibre optical waveguide.

In all cases, immediately prior to coating the end of the monofibre, the monofibre is preferably freshly cleaved to yield a perfectly smooth, planar surface that is chemically pristine. Alternatively it may be polished. A third alternative is to chemically etch the end of the monofibre. After cleaving, polishing or etching the monofibre end may be doped with metal ions. A fourth alternative is to allow a self-assembled monolayer to form on the end of the monofibre, which can be used to confer different chemical functionalities (such as amine or carboxylate) onto the end of the monofibre.

### EXAMPLES

The present invention may be further understood with reference to the examples below, which do not limit the invention. The examples provided demonstrate that the present invention can be used to detect vapours and aerosols in a gaseous medium.

All the examples were obtained with a setup (cf. GB 2428290 B and U.S. Pat. No. 7,876,447 B2) in which the light source was a diode laser emitting at 1310 nm and all monofibre waveguides were monomode and made from silica. The light source (diode laser), light detector (photodiode) and end-coated monofibre waveguide were connected with a circulator (cf. FIG. 1).

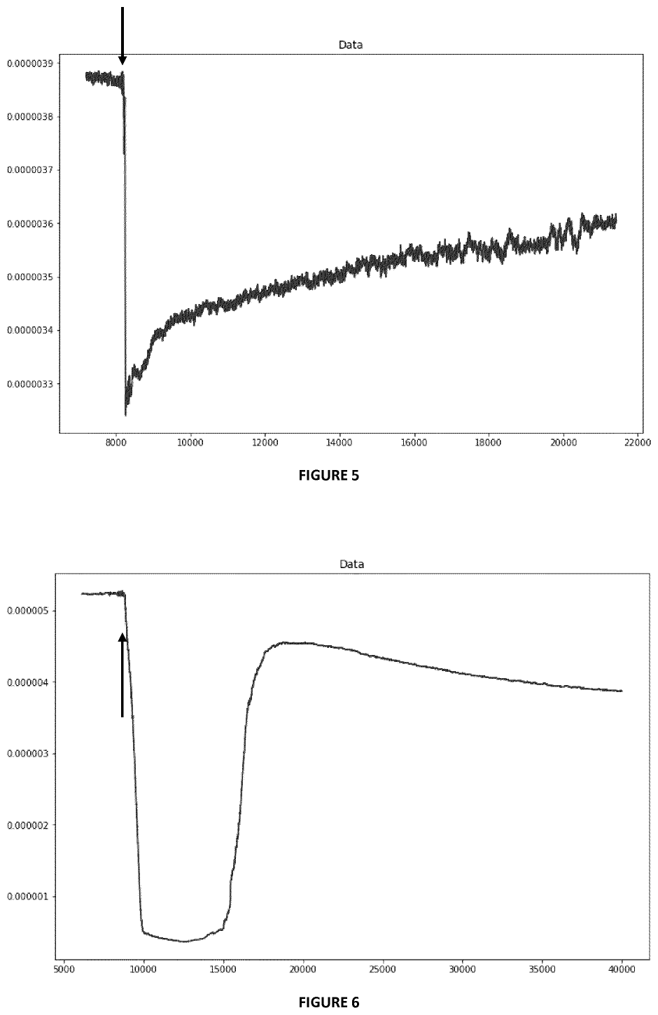

Example 1. The reactive film made from nanoparticles of mean diameter 90 nm of the MOF called ZIF-8, exposed to ethanol vapour (FIG. 5). The pores of ZIF-8 are spherical and have a diameter of 1.16 nm. The response can be compared with that from silica, the optical fibre material, shown in FIG. 3.

Example 2. The reactive film made from nanoparticles of the MOF called ZIF-8, exposed to tributyl phosphate vaporized at 280° C. (FIG. 6).

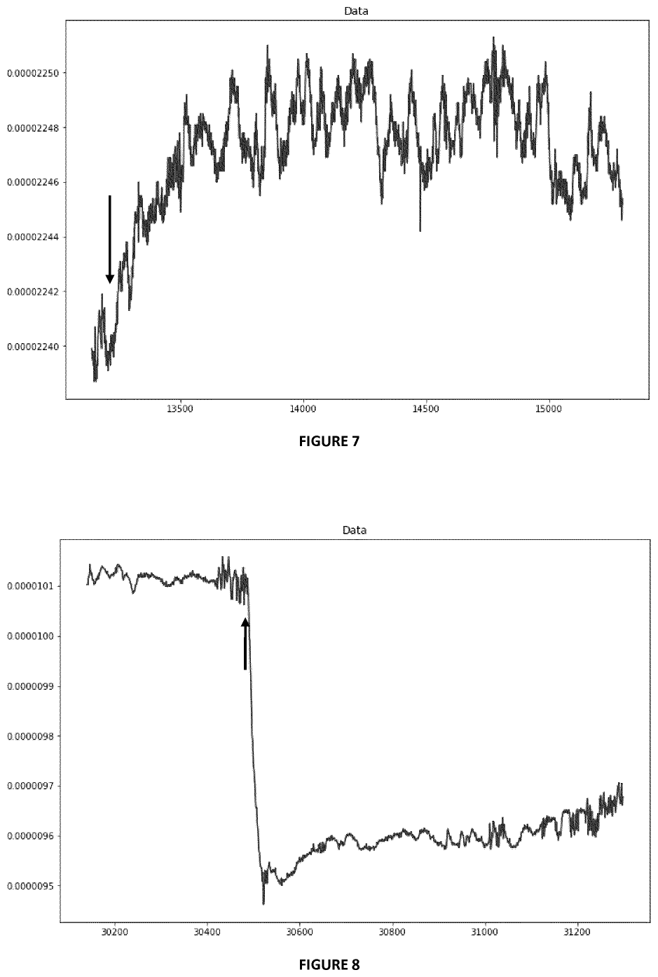

Example 3. The reactive film made from nanoparticles of the MOF called ZIF-8, exposed to tricresyl phosphate vaporized at 590° C. (FIG. 7).

Example 4. The reactive film made from nanoparticles of mean diameter 400 nm of the MOF called A520, exposed to ethanol vapour (FIG. 8). The pores of A520 are lozenge-shaped and have diameters of 0.57 and 0.60 nm.

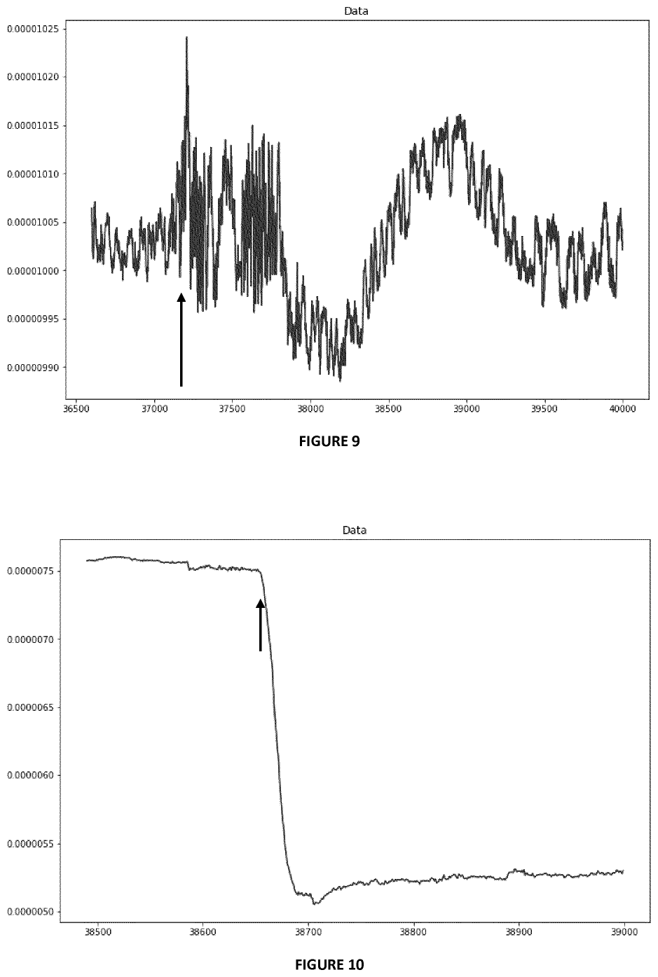

Example 5. The reactive film made from the MOF called A520, exposed to tricresyl phosphate vaporized at 590° C. (FIG. 9).

Example 6. The reactive film made from nanofibres of mean diameter 95 nm of the MOF called M050, exposed to ethanol vapour (FIG. 10). The pores of M050 have a mean diameter of 0.48 nm.

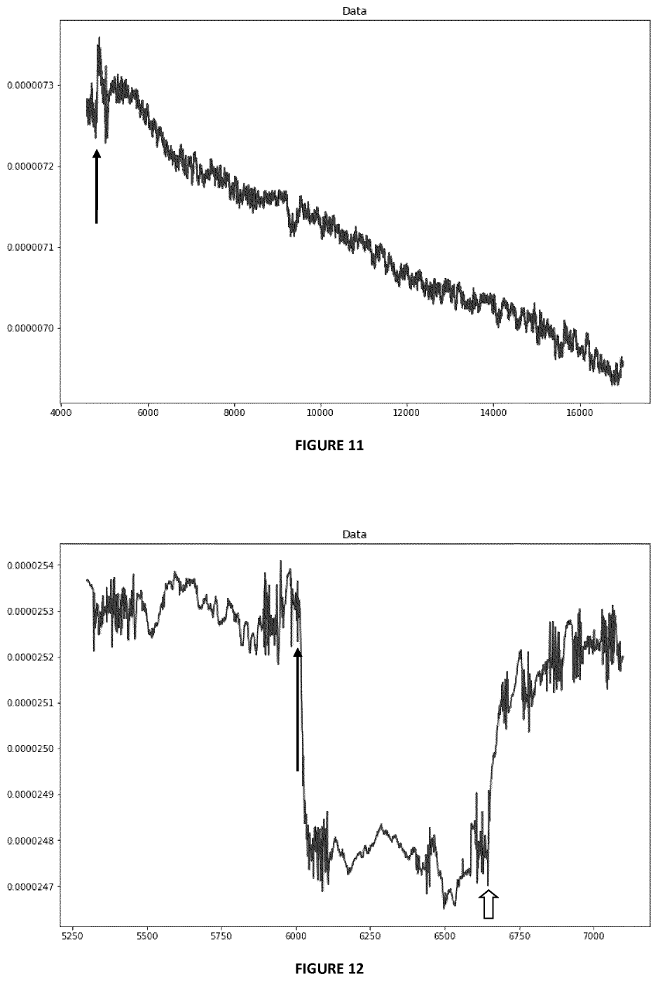

Example 7. The reactive film made from the MOF called M050, exposed to tricresyl phosphate vaporized at 590° C. (FIG. 11).

Example 8. The reactive film made from the MOF called ZIF-8, exposed to a mixture of formaldehyde/methanol/water vapour (FIG. 12).

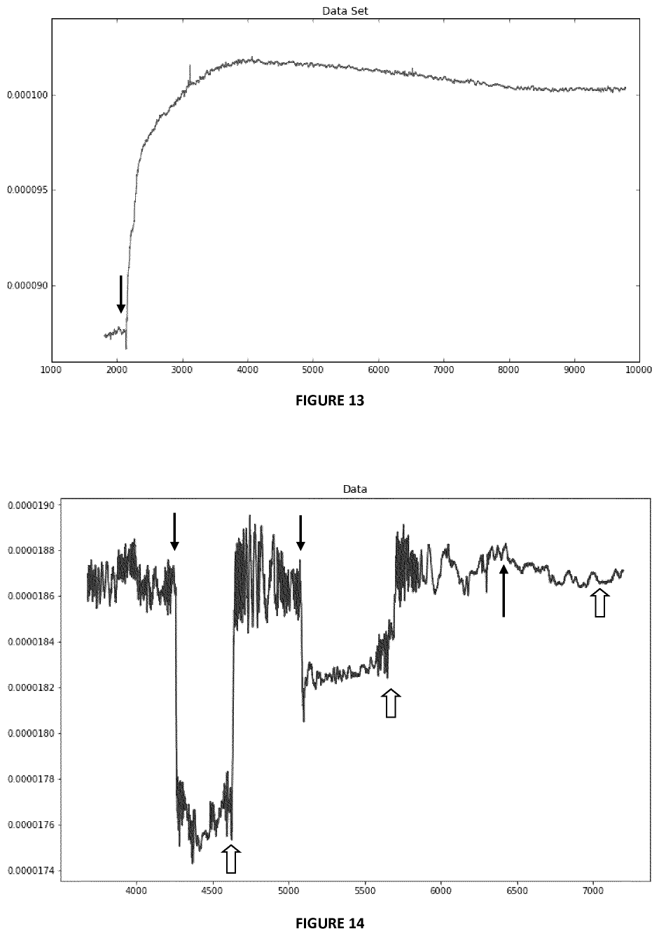

Example 9. The reactive film made from nanoparticles of mean diameter 60 nm of the MOF called MIL-101, exposed to tricresyl phosphate vaporized at 590° C. (FIG. 13). The pores of MIL-101 are spherical and have a diameter of 2.5-3.0 nm. Note how much faster and greater is the response to this large molecule compared with MOF M050 (Example 7), which has much smaller pores.

Example 10. The reactive film made from the PIM that is formed by the polycondensation reaction of 5,5,6,6-tetrahydroxy-3,3,3,3-tetraethyl-1,1′-spirobisindane with tetrafluoroterephthalonitrile, exposed to, from left to right on the figure, formaldehyde/methanol/water vapour and ethanol vapour (FIG. 14). The pores of this PIM are irregular with a bimodal distribution of diameters centred on 2 and 7 nm, the latter being much less numerous than the smaller ones.

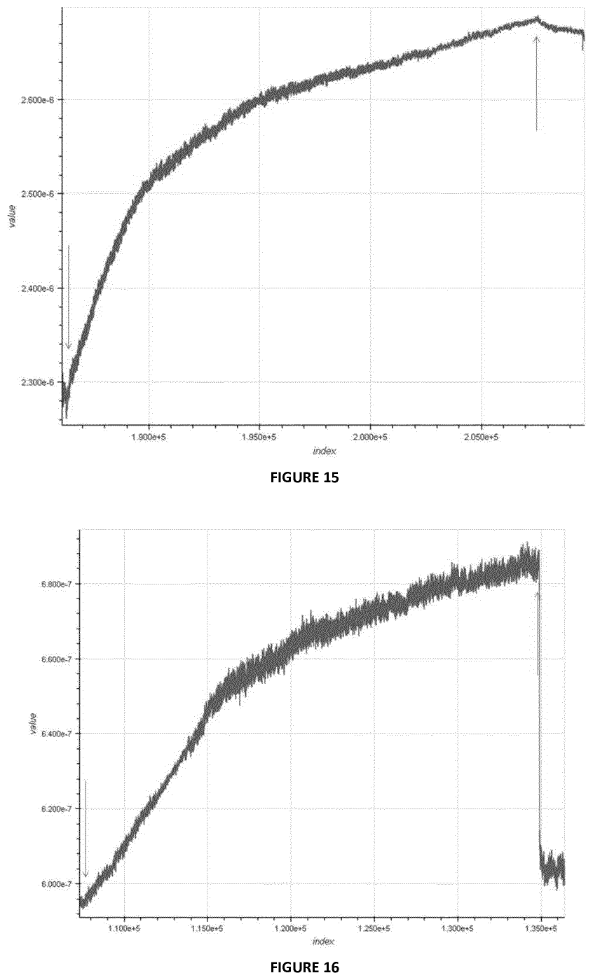

Example 11. The reactive film made via LPE (100 layers) of the MOF made from metal Co(II) and linker 4,4′-naphthalene dicarboxylic acid, suddenly exposed to tributyl phosphate (TBC) pyrolysed at 280° C. at the first arrow, with the TBC being completely removed at the second arrow (FIG. 15). This example shows the practical irreversibility of the response to TBC, making this sensor useful for dosimetry.

Example 12. The reactive film made via LPE (100 layers) of the MOF made from metal Co(II) and linker 4,4′-naphthalene dicarboxylic acid, exposed to toluene (FIG. 16). This example shows the complete reversibility of the response to toluene.

It will be appreciated that the invention may be modified within the scope of the claims.

1. A sensor for use in detecting an analyte, the sensor comprising a monofibre waveguide and a reactive film comprising a nanoporous material disposed at a distal end of the monofibre waveguide, wherein the nanoporous material comprises a metal-organic framework, the sensor having been manufactured by a method comprising immersing the distal end of the monofibre waveguide into a solution of the metal moiety and the organic moiety of the framework and synthesizing the metal-organic framework on the distal end of the monofibre waveguide.

2. A sensor according to claim 1 wherein the monofibre waveguide is a single mode monofibre waveguide.

3. A sensor according to claim 1 wherein the nanoporous material comprises one or more of: pores, wherein the pores are less than 100 nm in diameter; an inorganic nanoporous material; a zeolite; a polymer; a cross-linked polymer; a polymer of intrinsic microporosity; a nanoporous sol-gel; and a hybrid inorganic-organic material.

4. (canceled)

5. (canceled)

6. (canceled)

7. (canceled)

8. (canceled)

9. (canceled)

10. (canceled)

11. A sensor according to claim 1, wherein the nanoporous material comprises a hybrid inorganic-organic material and is a metal-organic framework.

12. A sensor according to claim 1, wherein the nanoporous material is one or more of: crystalline or polycrystalline or amorphous; provided as a plurality of nano-objects having an average particle size of less than 1000 nm; provided as a plurality of nano-objects having an average particle size of less than 200 nm; provided as a plurality of nano-objects having an average particle size of less than 80 nm; and a flexible nanoporous material.

13. (canceled)

14. (canceled)

15. (canceled)

16. (canceled)

17. A sensor according to claim 1, wherein the nanoporous material is a flexible nanoporous material and has a Young's modulus less than 10 Gpa or less than 1 GPa.

18. (canceled)

19. A sensor according to claim 1 wherein the nanoporous material is a flexible nanoporous material, wherein the flexible nanoporous material comprises a unit cell, and wherein a dimension of the unit cell upon ingress of the analyte into the nanoporous material changes by at least 2%, preferably at least 5%, more preferably at least 10%, more preferably at least 20%, or more preferably at least 30%.

20. A sensor according to claim 1 wherein the nanoporous material is a flexible nanoporous material, wherein the flexible nanoporous material comprises a pore, and wherein a volume of the pore upon ingress of the analyte into the nanoporous material increases by at least 10%, preferably at least 20%, more preferably at least 50%, more preferably at least 100%, more preferably at least 200%,or more preferably at least 300%.

21. An apparatus for detecting an analyte in a medium, the apparatus comprising a sensor according to claim 1 that, in use, is placed in contact with a medium, such that, in use, an interference pattern representative of the presence of the analyte is produced due to a reflexion at an interface between the monofibre waveguide and the reactive film interfering with the reflexion at an interface between the reactive film and the medium.

22. An apparatus according to claim 21 comprising a circulator or a Y-splitter having an input channel, an output channel and a common channel, preferably wherein the input channel provides an input signal to the common channel that is reflected from the interface with the medium and provides an output signal via the common channel to the output channel.

23. Apparatus according to claim 22 wherein the input signal is provided by one or more radiation sources, wherein the one or more radiation sources is configured to provide visible light or infrared.

24. An apparatus according to claim 23, wherein a coherence length of the radiation source is greater than a thickness of the reactive film.

25. Apparatus according to claim 22 wherein the output signal is provided to a radiation detector.

26. An apparatus according to claim 21 comprising a further sensor according to claim 1, wherein the nanoporous material of each sensor is different.

27. (canceled)

28. (canceled)

29. (canceled)

30. (canceled)

31. (canceled)

32. A method of manufacturing a sensor comprising a monofibre waveguide and a reactive film comprising a nanoporous material disposed at a distal end of the monofibre waveguide, wherein the nanoporous material comprises a metal-organic framework, the method comprising immersing the distal end of the monofibre waveguide into a solution of a metal moiety and an organic moiety of the framework and synthesizing the metal-organic framework on the distal end of the monofibre waveguide.

33. A method of according to claim 32, wherein the metal-organic framework is flexible, and comprises a metal moiety and an organic moiety, wherein the method comprises:
after immersing the distal end of the monofibre waveguide into a solution comprising the metal moiety, rinsing the distal end or allowing a solvent of the solution comprising the metal moiety to evaporate, and
after immersing the distal end of the monofibre waveguide into a solution comprising the organic moiety, rinsing the distal end or allowing a solvent of the solution comprising the organic moiety to evaporate.

34. A method according claim 33 wherein, prior to immersion, the distal end of the monofibre waveguide is contacted with a polyion.

35. A method according to claim 33, wherein, prior to initial immersion, the distal end of the monofibre waveguide is contacted with a salt comprising the metal moiety of the framework, and immersed in a solution comprising the organic moiety of the framework.

36. A method according to claim 33, wherein, prior to the initial immersion, the distal end of the monofibre waveguide is contacted with a dissolved precursor of a monolayer of functionality that is capable of self-assembly and is appropriate to bind the metal moiety of the framework, and allowing the precursor to self-assemble and form the monolayer.

37. (canceled)

38. (canceled)

39. A method of detecting an analyte in a medium, comprising providing a sensor according to claim 1, placing the sensor in contact with a medium, providing a radiation in the monofibre waveguide to produce an interference pattern due to reflexions at an interface between the monofibre waveguide and the reactive film and an interface between the reactive film and the medium, and using the interference pattern to detect or quantify the presence of the analyte in the medium.

40. A method of quantifying a concentration of an analyte in a medium, comprising:
(i) providing a sensor according to claim 1 and a reactive film comprising a nanoporous material having a responsivity to the analyte;
(ii) providing radiation in the monofibre waveguide and measuring a first reflected radiation;
(iii) placing the sensor in contact with the analyte-containing medium, and measuring a second reflected radiation; and
(v) determining a difference between the first and second reflected radiation and calculating a concentration of the analyte from the difference based on the responsivity.

41. A method according to claim 40, wherein concentrations of multiple analytes in a medium are quantified by using several sensors simultaneously.

42. (canceled)
